(19) United States
(12) Patent Application Publication
(10) Pub. No.: US 2009/0072510 A1
(43) Pub. Date: Mar. 19, 2009

(54) WHEELCHAIR SUITABLE FOR PERFORMING ABDUCTION ACTIONS

(76) Inventor: Alexander MUELLER, Sinsheim (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/204,153

(22) Filed: Sep. 4, 2008

(30) Foreign Application Priority Data
Sep. 14, 2007 (DE) 10 2007 043 942.5

(51) Int. Cl. B62M 1/14

(52) U.S. Cl. 280/250.1

(57) ABSTRACT

A wheelchair for carrying out abduction actions is proposed, which is fitted with a frame (1, 2, 3, 4, 5, 11) provided to support a seat (16) and side parts (14) arranged on both sides of the seat (16) and connected detachably to the frame, which parts can be adjusted for carrying out abduction actions in their angled position to the seat (16) in that they can be swivelled about a vertical axis (V) running substantially perpendicular to the seating plane.

The invention relates to a wheelchair which is suitable for performing abduction actions. This wheelchair has a frame provided to support a seat forming a seating plane.

### BACKGROUND OF THE INVENTION

This type of wheelchair is disclosed for example in DE 295 09 698 U1. For therapy of wheelchair patients, children and youths in particular, it is often required to spread apart the legs for adjustment purposes. A wedge which spreads the legs outwards is affixed to the inner sides of the legs of the patient for this very purpose.

To avoid pressure points and wound sites when the spread legs bump and rub on the side frame parts, the latter are articulated in the front region to the frame tubes so that the sides can be widened outwards, at which point this widening can be adapted individually to the patient.

Abduction, therefore the angled position of the legs, already begins at the hips. With the known wheelchair however abduction begins only in the region of the knee of the patient, because only the front area of the side frame is adjustable.

Adjustment of the abduction is helpful also without necessary therapy activity, because it potentially offers the patient improved lateral stability, should this prove necessary.

In order to have abduction already commence in the hip region it is known to use a seat shell adapted to the angle. Abduction is then preset.

DE 91 12 908 U1 discloses a wheelchair frame, in which the side parts in the direction of travel are bent at right angles such that the seat area widens outwards. Abduction is preset here also.

### SUMMARY OF THE INVENTION

The wheelchair described at the outset is to be improved based on this statement of the problem.

To solve this problem a generic wheelchair is characterised in that side parts connected detachably to the frame are provided, arranged on both sides of the seat, and can be adjusted to carry out abduction actions in their angled position relative to the seat, in that they can be swivelled about a vertical axis running substantially perpendicularly to the seating plane.

This step allows the abduction to begin already in the hip region without using a seat shell adapted to the angle. As a result, abduction can be easily changed and adapted to the progress of convalescence.

Connection is preferably made via two rods arranged parallel to one another, which are bent out at right angles at their top end, and that the right-angle bends are configured substantially opposite one another.

This configuration enables the side parts to be arranged as usual parallel to the seat tube or respectively parallel to the seat tube. When both rods are rotated at the same time each side part can be adjusted at an angle individually. Since the side part can be adjusted over its entire length at an angle the seat width (abduction) can already be widened from the hips, so that anatomically correct leg positioning of the patient is maintained.

One rod is preferably bent out at right angles in the direction of travel and the other rod is bent out at right angles against the direction of travel. The adjustable angle is maximised by this design.

The top ends of the rods bent at right angles can be mounted in a receiving element, to which the side part can be attached, or directly in the side part.

The rods are preferably mounted in a fastening element connected to the frame by their bottom end. The rods are preferably designed round in cross-section for easy rotation of the rods and for progressive adjusting of the angle.

### BRIEF DESCRIPTION OF THE DRAWINGS

Embodiments of the invention will now be explained in greater detail hereinbelow by means of a diagram, in which:

FIG. 1 is a plan view of a wheelchair with parallel upright side parts;

FIG. 2 is a plan view of the wheelchair according to FIG. 1 with adjusted abduction of the side parts;

FIG. 3 is a view of the arrangement of the rods in side elevation;

FIG. 4 is the view according to FIG. 3 according to arrow IV;

FIG. 5 shows the view corresponding to FIG. 3 with set angle;

FIG. 6 shows the view according to FIG. 5 according to arrow VI;

FIG. 7 is an illustration corresponding to FIG. 3 with a support element;

FIG. 8 shows the view according to arrow VIII as per FIG. 7;

FIG. 9 shows the illustration according to FIG. 5 with an adapter;

FIG. 10 shows the view according to arrow X as per FIG. 9;

FIG. 11 is a side elevation according to arrow XI as per FIG. 1;

FIG. 12 is a perspective illustration of the wheelchair.

### DETAILED DESCRIPTION OF THE PREFERRED EMBODIMENT

The wheelchair comprises the frame made up of various tubes 1, 2, 3, 4, 5, 11 to which the rear wheels 8 and the steerable front wheels 6 are attached. The footrest 7 is attached to the frame tube 4. The seat tubes 5 support the seat 16 forming the seating plane 17. Attached to both seat tubes 5 is a downwards pointing tube 11, to which both rods 9, 10, round in cross-section, bent out at right angles at their top ends are attached via a fastening element 12.

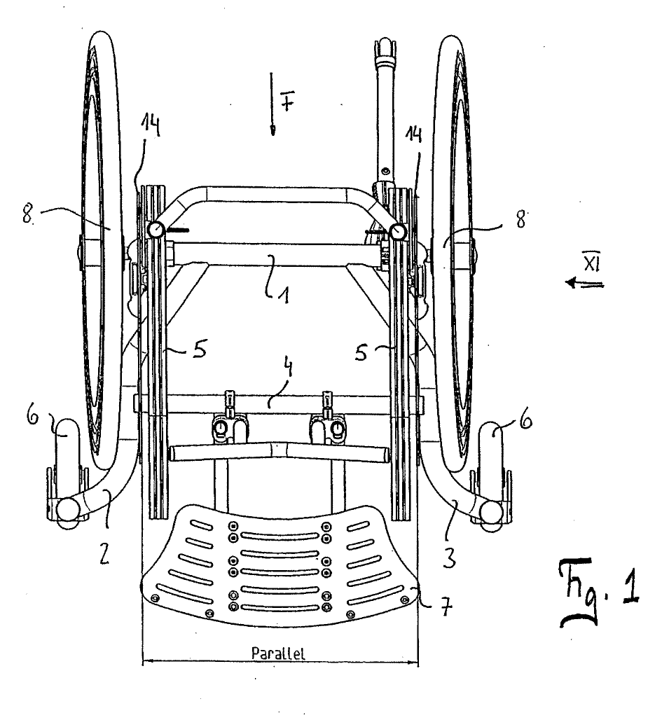

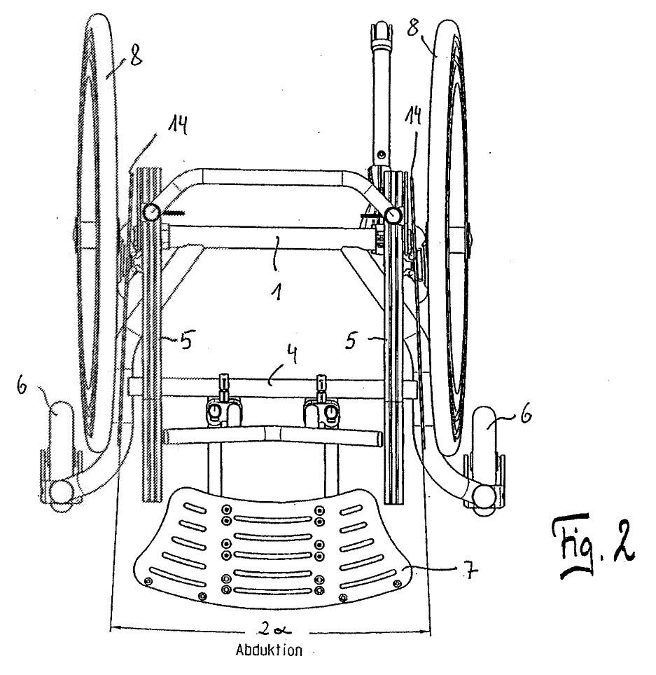

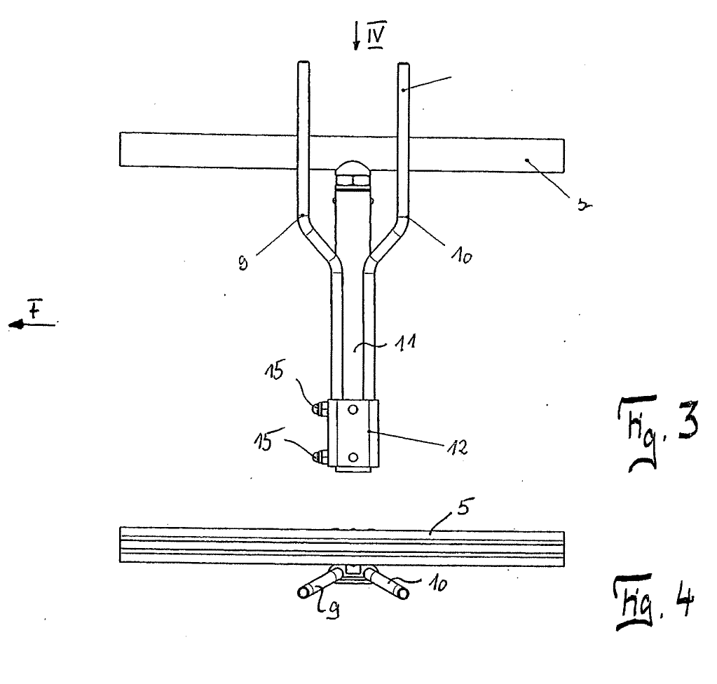

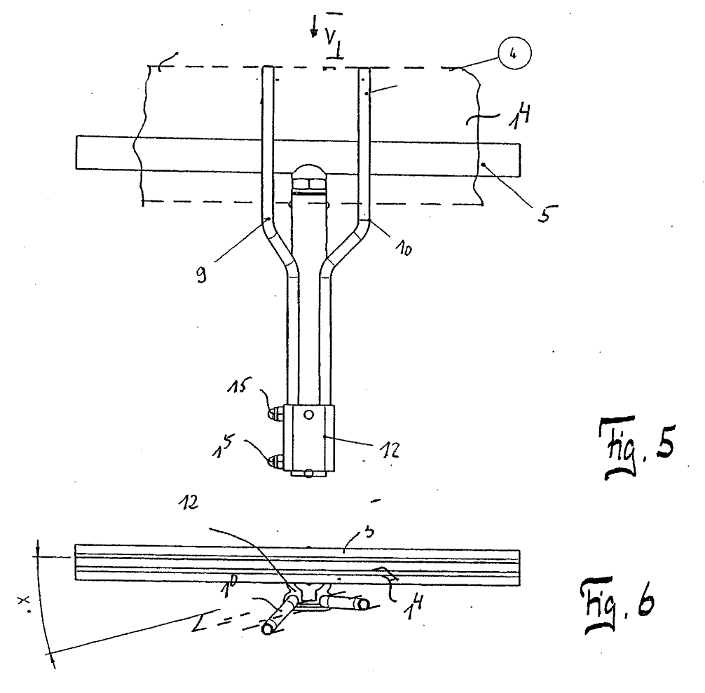

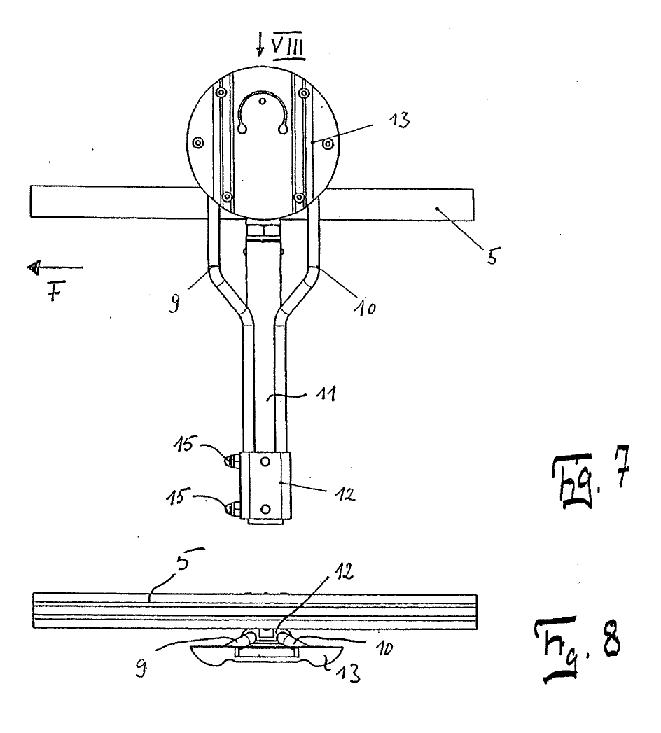

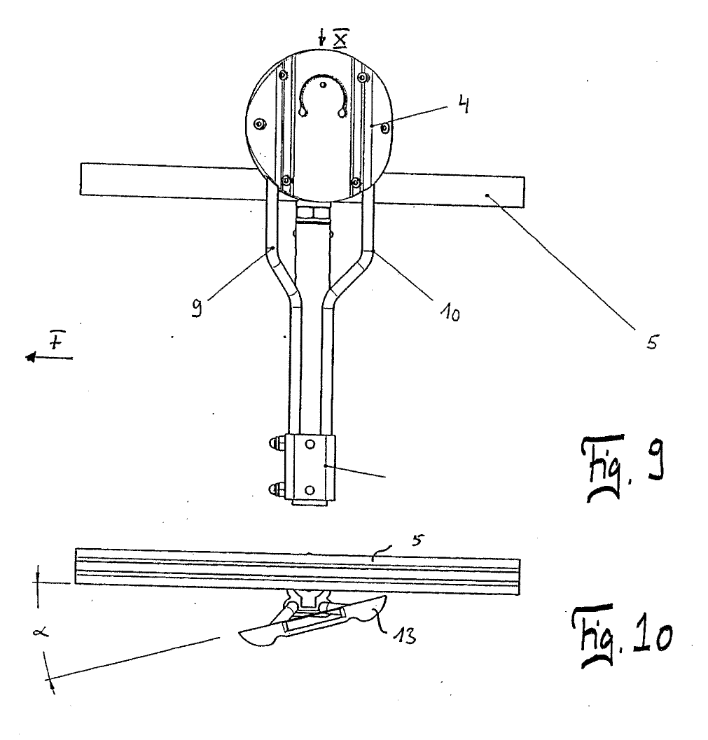

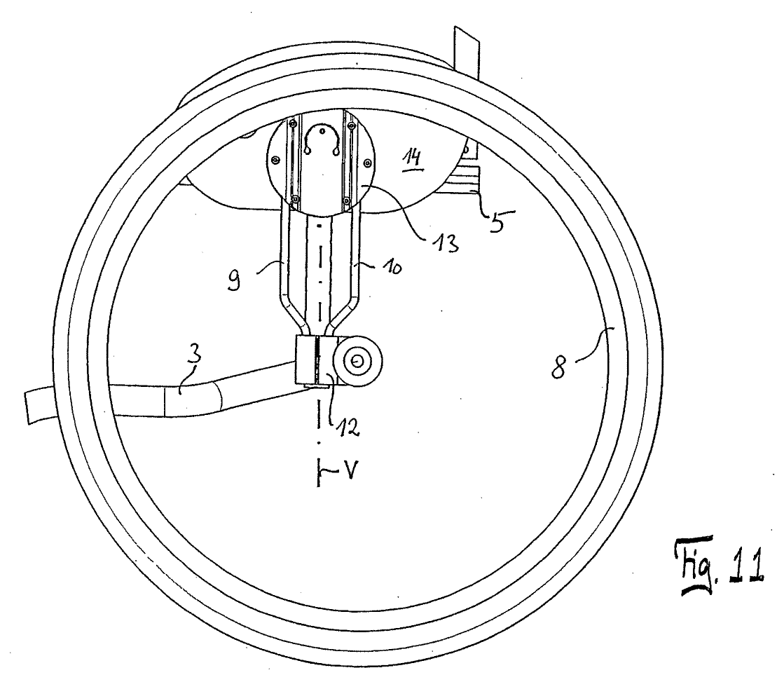

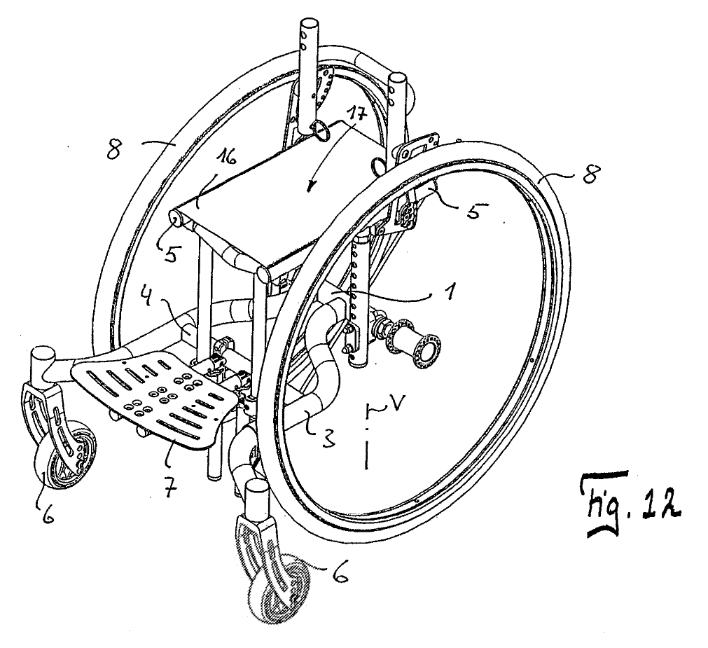

As indicated in FIGS. 5 and 6 by dashed lines, the side parts 14 can be connected directly to the top ends of the rods 9, 10 via an adapter 13, or as shown in FIGS. 7 and 8. To align the side parts (14) parallel to one another, or respectively parallel to the seat tubes 5, the rods 9, 10 in the fastening element are aligned such that the right-angle bends of the top ends lie substantially opposite one another, therefore the right-angle bend of the front rod 9 in the direction of travel F is set in the direction of travel F and of the rear rod 10 is set against the direction of travel F symmetrically to the vertical axis V running substantially perpendicularly to the seating plane 17 (cf. FIGS. 1, 3, 7). The top ends of the rods 9, 10 can be mounted rotatably in the adapter 13 or respectively the side parts 14. To adjust abduction, the screws 15 on the fastening element 12 are loosened and the rods 9, 10 are rotated at the same time to one another and about the axis V so that the side part 14 or respectively the adapter is at an angle α to the seat tube 5. The distance of the rods 9, 10 from one another remains constant throughout rotation, which occurs about the axis V (middle axis) between both rods 9, 10. When the correct angle α is set the fastening screws 15 are retightened.

### LEGEND

1 frame tube
2 frame tube
3 frame tube
4 frame tube
5 seattube
6 front wheel
7 footrest
8 rear wheel
9 rod
10 rod
11 tube
12 fastening element
13 adapter
14 side part
15 screw
16 seat
17 seating plane
V axis/longitudinal axis/middle axis

1. A wheelchair with a frame (1, 2, 3, 4, 5, 11) provided to support a seat (16) and side parts (14) arranged on both sides of the seat (16) and connected detachably to the frame, which can be adjusted to carry out abduction actions in their angled position to the seat (16) in that they can be swivelled about a vertical axis (V) running substantially perpendicularly to the seating plane (17).

2. The wheelchair as claimed in claim 1, characterised in that the each of the side parts (14) is connected to the frame via two rods (9, 10) arranged parallel to one another, in that the rods (9, 10) are bent out at right angles at their top ends, and in that the right-angle bends are designed for parallel alignment of the side parts (14) arranged substantially opposite one another.

3. The wheelchair as claimed in claim 2, characterised in that one rod (9) is bent out at right angles in the direction of travel (F) and the other rod (10) is bent out at right angles against the direction of travel (F).

4. The wheelchair as claimed in claim 2, characterised in that the top ends of the rods (9, 10) are mounted in a receiving element to which the side part (14) can be attached.

5. The wheelchair as claimed in claim 2, characterised in that the top ends of the rods (9, 10) are mounted in the side part (14).

6. The wheelchair as claimed in claim 4, characterised in that the rods (9, 10) are mounted with their bottom end in a fastening element (12) connected to the frame (11).

7. The wheelchair as claimed in claim 1, characterised in that the rods (9, 10) are round in cross-section.
